(19) United States
(12) Patent Application Publication
(10) Pub. No.: US 2020/0272994 A1
(43) Pub. Date: Aug. 27, 2020

(54) RESUME UPDATER RESPONSIVE TO PREDICTIVE IMPROVEMENTS

(71) Applicant: ADP, LLC, Roseland, NJ (US)

(72) Inventors: Roberto Silveira, SAO PAULO (BR); Roberto Dias, SAO PAULO (BR); Leandro Eidelwein, PORTO ALEGRE (BR); Andre Mendes, PORTO ALEGRE (BR); Bruna Gouveia, PORTO ALEGRE (BR); Rafael Gomes, PORTO ALEGRE (BR); Eduardo Hoefel, PORTO ALEGRE (BR)

(21) Appl. No.: 16/284,041

(22) Filed: Feb. 25, 2019

(51) Int. Cl. G06Q 10/10; H04L 12/58; G06N 20/00; G06K 9/62

(52) U.S. Cl. CPC G06Q 10/1053; H04L 51/02; G06K 9/6218; G06K 9/6267; G06N 20/00

(57) ABSTRACT

Aspects map candidate resume data values to a resume metadata representation of the candidate defined by data dimensions stored within a metadata repository that includes resume metadata representation data dimensions of a plurality of candidates; learn via a machine learning process different trending demand values for job classifications within the dimensional data as a function of employment data; identify via the machine learning process an upwardly trending job position skill missing from the candidate data dimensions and most likely to match a current skill set of the candidate; add the identified skill to the first candidate data dimensions; and generate a resume for the first candidate as a function of the first candidate data dimensions to include the added skill.

### BACKGROUND

Human resource management (sometimes “HRM” or “HR”) generally refers to functions and systems deployed in organizations that are designed to facilitate or improve employee, member or participant performance in service of an organization or employer's strategic objectives. HR comprehends how people are identified, categorized and managed within organizations via a variety of policies and systems. Human Resource management systems may span different organization departments and units with distinguished activity responsibilities: examples include employee retention, recruitment, training and development, performance appraisal, managing pay and benefits, and observing and defining regulations arising from collective bargaining and governmental laws. Human Resource Information Systems (HRIS) comprehend information technology (IT) systems and processes configured and utilized in the service of HR, and HR data processing systems which integrate and manage information from a variety of different applications and databases.

Resumes comprehend, curriculum vitae (CV), “biodata” and other documents or audial and visual media that are used by a person to present their backgrounds and skills, often in association with seeking or securing new employment. A conventional resume document generally includes an employment objective, work history or relevant job experience (sometimes inclusive of salary information), and educational background information that is used by a potential employer to screen applicants. Curriculum vitae may present a shorter, more-summarized version of candidate education and experience relative to the conventional resume document, or they may present more in-depth information, as is common in academic forums. The biodata document is often used in India, Pakistan, Bangladesh and other South Asian countries, and generally includes conventional resume document information as well as physical attributes of the application (for example, text data describing height, weight, and color of hair, skin complexion and eye iris, and a photographic image).

### SUMMARY

In one aspect of the present invention, a method includes a processor mapping values of resume data for a first candidate to a resume metadata representation of the first candidate defined by data dimensions and are stored within a metadata repository, wherein the metadata repository includes resume metadata representation data dimensions for a plurality of candidates; learning via a machine learning process different trending demand values for each of a plurality of job classifications within the dimensional data as a function of employment data; identifying via the machine learning process, as a function of the learned trending demand values and of values of the first candidate data dimensions, a skill of an upwardly trending job position that is missing from the first candidate data dimensions and is most likely to match a current skill set of the first candidate; adding the identified skill of the upwardly trending job position to the first candidate data dimensions; and generating a resume for the first candidate as a function of the first candidate data dimensions to include the added skill.

In another aspect, a system has a hardware processor in circuit communication with a computer readable memory and a computer-readable storage medium having program instructions stored thereon. The processor executes the program instructions stored on the computer-readable storage medium via the computer readable memory and thereby maps values of resume data for a first candidate to a resume metadata representation of the first candidate defined by data dimensions that are stored within a metadata repository, wherein the metadata repository includes resume metadata representation data dimensions for a plurality of candidates; learns via a machine learning process different trending demand values for each of a plurality of job classifications within the dimensional data as a function of employment data; identifies via the machine learning process, as a function of the learned trending demand values and of values of the first candidate data dimensions, a skill of an upwardly trending job position that is missing from the first candidate data dimensions and is most likely to match a current skill set of the first candidate; adds the identified skill of the upwardly trending job position to the first candidate data dimensions; and generates a resume for the first candidate as a function of the first candidate data dimensions to include the added skill.

In another aspect, a computer program product has a computer-readable storage medium with computer readable program code embodied therewith. The computer readable program code includes instructions for execution which cause the processor to map values of resume data for a first candidate to a resume metadata representation of the first candidate defined by data dimensions that are stored within a metadata repository, wherein the metadata repository includes resume metadata representation data dimensions for a plurality of candidates; learn via a machine learning process different trending demand values for each of a plurality of job classifications within the dimensional data as a function of employment data; identify via the machine learning process, as a function of the learned trending demand values and of values of the first candidate data dimensions, a skill of an upwardly trending job position that is missing from the first candidate data dimensions and is most likely to match a current skill set of the first candidate; add the identified skill of the upwardly trending job position to the first candidate data dimensions; and generate a resume for the first candidate as a function of the first candidate data dimensions to include the added skill.

### BRIEF DESCRIPTION OF THE SEVERAL VIEWS OF THE DRAWINGS

These and other features of this invention will be more readily understood from the following detailed description of the various aspects of the invention taken in conjunction with the accompanying drawings in which:

FIG. 1 is a flow chart illustration of a method or process aspect according to an embodiment of the present invention.

FIGS. 2A and 2B are graphic illustrations of an example of an implementation according to an embodiment of the present invention.

FIG. 3 is a flow chart illustration of another method or process aspect according to an embodiment of the present invention.

FIG. 4 is a graphic illustration of an example of another implementation according to an embodiment of the present invention.

### DETAILED DESCRIPTION

Conventional HR resume generation, recording (archiving) and updating (maintenance) and retrieval systems and processes are generally deficient in timely updating resume information, resulting in data inaccuracies. People often neglect to review and update their resumes on a regular basis, and commonly enter updates only when they are required to by management entities, or when they decide to look for a new employment position. Cultural norms and issues may also discourage professionals from consistently and regularly updating their resumes, lest they be perceived as unhappy with or actively trying to leave a current employer, thereby presenting a heightened risk of loss to the current employer (via taking confidential information with them to a competitor, etc.).

When updates or prompts occur infrequently, candidates experience a corresponding increase in risk of loss from forgetting to add important skills or achievements that occurred in interviewing time periods, wherein the failure to add such information may work to the detriment of the candidate relative to other candidates with resumes including the omitted skills and experience, resulting in failure to secure a new job or a salary increase, etc.

The dynamic nature of employer resume information requirements may also result in data deficiencies unless the resume documents are regularly reviewed and revised to meet new requirements as they arise. As different national jurisdictions may dynamically revise their expected resume formats at different times (for example, to meet different respective changes in cultural preferences), conventional HR resume systems and processes that rely on singular, user-maintained resume data may fail to meet current expected or required resume data formats and data values for each of a plurality of different, specific countries.

Conventional HR resume systems and processes also require lengthy and tedious efforts on the part of the candidate to both create and maintain an updated resume, sometimes across a variety of different required documents, object or other data structures and formats, including non-standard or organization-specific (and exclusive) data forms. Conventional tools, portals and social media platforms for professionals may also require that updates be performed or initiated directly by a candidate, which may impose additional log-in tasks and credential management duties on the candidate.

Outdated resume data tends to reflect poorly on the professionalism of a candidate, and on the management competency of organizations that employ employees that are associated to inaccurate or outdate resume information. Poorly maintained resumes may harm the perceived professionalism or employability of a candidate, reflecting poor competency, and inadequate work experience or professional development from missing listings of expected or minimum competencies, or lack of use of current, market-standard keyword with respect to certain knowledge areas, presenting a poor, stale or outdated resume format model, one that is visually unacceptable, lacking standard items and formats, etc.

Stale resume formats and data values provided under conventional HR resume systems and processes may also be difficult to accurately translate to different languages and expected data formats for candidate utilizing such formats to apply to positions in different organizations, departments or foreign jurisdictions. The value of resume data within conventional HR resume systems and processes may also be limited when an organization does not update job titles, or uses non-standard job titles that do not have similar or corresponding usage within positions encompassing the same job or job duties within other organizations and jurisdictions, rendering the information of correspondingly diminished use in assessing the suitability of a candidate for a relevant position.

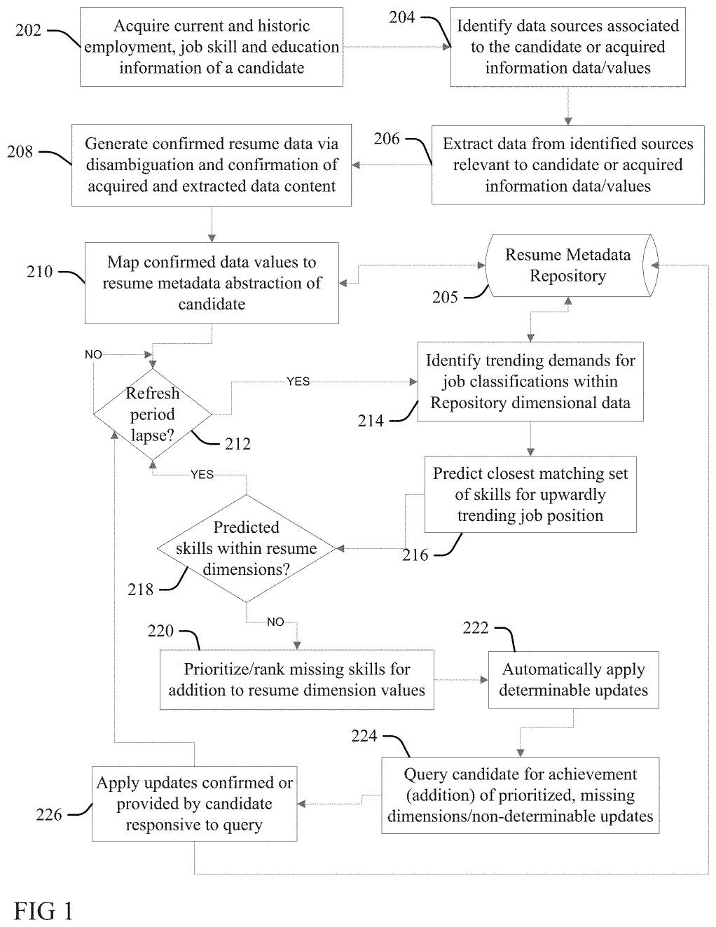

Aspects of the present invention provide advantages over conventional HR resume systems and processes in solving problems discussed above. FIG. 1 illustrates a method or process embodiment of the present invention for autonomous, dynamic and interactive resume generation and update (revision, etc.) based on predictive improvements determined through machine-learning and artificial intelligence processes. At 202 a processor configured according to the present invention (the “configured processor”) acquires current and historic employment, job skills and education information of a candidate (organization employee, prospective employee, intern, student, independent contractor, etc.); for example, in response to a question-and-answer form or template displayed or provided to the candidate.

At 204 the configured processor identifies data sources that are relevant or associated to the candidate or to the current and historic employment, job skills and education information data and values acquired at 202, and at 206 extracts additional data from the identified sources that is relevant or associated to the candidate or to the current and historic employment, job skills and education information data and values acquired at 202. A wide variety of data sources may be identified at 204, and the additional data extracted therefrom at 206, and illustrative but not exhaustive examples include:

(i.) Text content extracted via performing optical character recognition (OCR) processing on printed resume documents, cover letters, candidate application paperwork and other image information identified at 204 as relevant or associated to the candidate as the data and values acquired at 202.

(iii.) Data extracted from social media services, such as changes to marital status, domicile, residence, nationality, visa status, job, education or employer information extracted from postings by the candidate or social connections to Facebook®, Instagram®, LinkedIn® or other social and professional networking media services linked to the candidate at 204 (FACEBOOK and INSTAGRAM are trademarks of Facebook, Inc. in the United States or other countries; LINKEDIN is a trademark of Linkedln Corp. in the United States or other countries). For example, the configured processor may perform image analysis at 206 of a picture posted in a social media account of a friend of the candidate identified at 204 wherein the candidate is tagged and thereby determine (via comparison to labelled images, or fitting image data masques, etc.) that the candidate is wearing a graduation robe, which when considered in view of text content associated with the image processed via Natural Language Processing (NLP) techniques (“Big State University graduation, so proud!”) results in a determination that the candidate has likely earned additional education credentials, which further triggers a search for the name of the candidate within a publication of Big State University of the date of the metadata of the image or posting that lists the names of graduates and their awarded degrees and honors, which results in a determination that the candidate has earned a Masters of Science degree in Electrical Engineering with Honors from Big State University on said date.

(iv.) Data extracted from text content of newsfeeds, governmental records, credit report agency records, insurance company records, or other external public and/or private sources determined at 204 as relevant or associated to the candidate as the data and values acquired at 202. For example, the weather and climate data for residence, work and travel locations of the candidate; employment-related news and announcements, for example, construction of new headquarters in one location, or closure of offices in another location, projected new hires and job categories, etc.; and new regional tax locations, exemptions, visa programs, etc., within specific geographic regions identified at 204 as relevant or associated to the candidate or to the employment titles and data values of the candidate acquired at 202.

(v.) Mobile device data: this is data and metadata extracted from the cell phone, tablet or other personal mobile programmable device of the candidate, including operating system and current and historic geolocation data.

At 208 the configured processor executes disambiguation and other data confirmation processes on the acquired and extracted text content data to generate confirmed data, generally by selecting (most likely) semantic meanings of the extracted text content from a plurality of possible meanings of word content as a function of context. Disambiguation at 208 may comprehend natural language processing sentence boundary disambiguation (deciding where text string sentences begin and end), syntactic disambiguation, semantic disambiguation, and still others will be apparent to one skilled in the art.

At 210 the configured processor maps the confirmed resume data values to a resume metadata abstraction or representation of the candidate stored within a Resume Metadata Repository 205. The mapping at 210 generally de-normalizes the data information into a plurality of data dimensions that define a resume meta representation (instantiation) of the candidate. Mapping at 210 may transform a data element (salary, date of hire, etc.) that varies by data values, type or format across different employees, or organizations or departments, into a uniform, structured data of a specified or common value, data type or format. Processes or systems applied at 210 include a Job Title Classifier that outputs a single, common job classification code “SOC (15 -1133.00)—Software Developers” for inputs of each of a plurality of different employee job titles or defined duties, skills or functions of the employees, including text string content derivative descriptions of “Hadoop engineer” and “Machine learning engineer,” etc., thereby resolving different input values to a same, common job title code. An “Employee-type Clusterer” may identify type values for employees by finding commonalities across job title, duties, task, etc.: for example, a plurality of employees may be labeled (or assigned) an “Accounts receivable Services” type in response to determining that they each have duties that include the receipt and approval of payments from vendors or consumers. Still other examples will be apparent to one skilled in the art.

At 212 the configured processor periodically (upon lapse of a specified refresh period) initiates (executes) a machine learning process wherein the configured processor at 214 identifies trending of demands for job classifications within the Resume Metadata Repository dimensional data for pluralities of different candidates inclusive of the present candidate as a function of employment data. The refresh period may be any specified time period (illustrative but not limiting or exhaustive examples include weekly, monthly, quarterly, yearly, biennially, etc.); or lapse may be triggered in response to an event occurrence (illustrative but not limiting or exhaustive examples include a promotion of the candidate, a new job title assignation, transfer to a different organization division, etc.).

At 216 the configured processor (via the machine learning process), as a function of values of the candidate data dimensions, predicts (learns) at least one closest (most likely) matching skill or set of skills for an upwardly trending job position (one for which demand or compensation is trending upward relative to other job positions) that most likely matches a current skill set of the candidate.

In some embodiments at 214 and 216 the configured processor executes multi-agent artificial intelligence (AI) processes comprising parallel executions of a plurality of deep-learning machine learning algorithms (for example, big-data preprocessing and classification, topic modeling, clustering, regression and classification, etc.) in order to identify missing skills and job positions and thereby predicted, trending behavior.

At 218 the configured processor determines whether the predicted, most-likely matching skills are present within the candidates resume metadata dimensions. If so (“YES”), the configured processor returns to await the lapse of the next refresh period at 212; otherwise, in response to determining that the predicted skills are not currently present within the candidates resume metadata dimensions at 218 (“NO”), at 220 the configured processor prioritizes or ranks the missing skills for addition to resume dimension values of the candidate (for example, prioritizing the most valuable missing skills in terms of enhancing employability over other similar candidates, or those that are associated with higher salary, over remaining others of the missing dimension values.)

At 222 the configured processor automatically applies determinable updates to reflect the missing information: for example, updating “years of experience” values to reflect additional experience time accrued since a last update of the candidate resume data, or to reflect and increase in seniority relative to other co-workers within an employing organization or division thereof. Such automatic updates are made by the configured processor at 222 in the background, without requiring active involvement or approval of the candidate.

At 224 the configured processor queries the candidate for achievement (or addition) of prioritized, missing dimensions, or non-determinable updates, at 226 applies any updates confirmed or provided by the candidate responsive to said query to the dimensional resume data of the candidate stored in the Repository 205 and returns to 212 for determining lapse of the refresh period, thereby iteratively repeating the processes at 214 through 226 at each occurrence of lapse of the refresh period.

Generally the query-confirmation process at 224 and 226 is applied to updates predicted at 218 from the candidate resume meta representation (instantiation) data dimensions that are not confirmable by the configured processor via review of the data dimensions or acquired, extracted or confirmed data values mapped thereto, wherein the configured processor initiates and executes the query process with the candidate at 224 to determine whether the predicted updates should be applied to the resume metadata abstraction at 226.

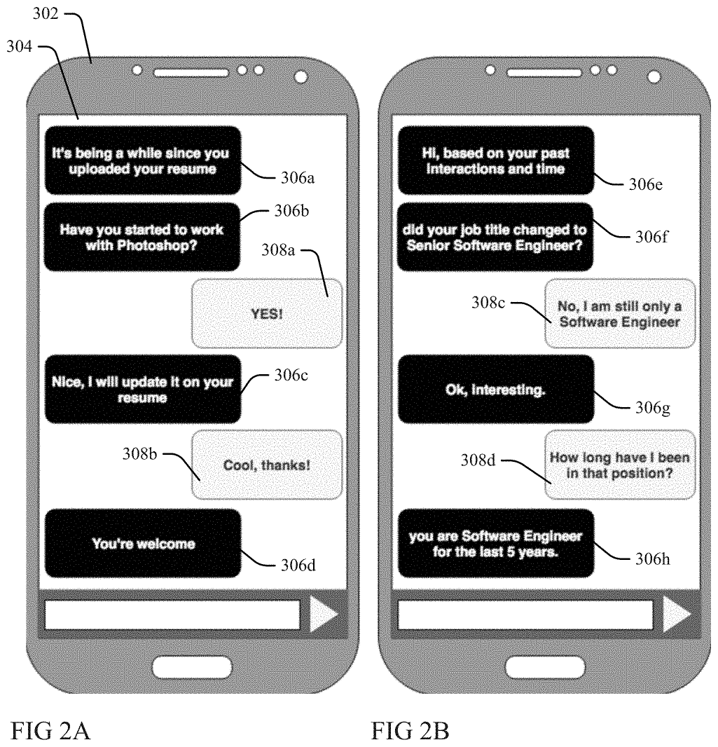

FIGS. 2A and 2B illustrate respectively two different examples of the processes at 224 and 226 of FIG. 1, wherein a processor configured pursuant to FIG. 1 is executing within (or in network communication with) a smart phone 302 of a candidate and evokes a chatbot agent application (a digital agent, built using machine learning, capable of handling human-like conversions) to drive a display screen 304 of the smart phone to engage in a chat conversation with the candidate that comprises a plurality of text content chat bot queries, answers or statements 306 (depicted in white font in black background) and respective responses 308 entered by the candidate (depicted in black font in white background).

In the examples of FIG. 2A and 2B, in response to lapse of a refresh period (FIG. 1 212), the configured processor initiates respective chat conversations with opening inquiries having text content that is conversational, colloquial form 306 aand 306 ethat inform the candidate of the lapse of the relevant refresh period: “It's been a while since you uploaded your resume,” and “Hi, based on your past interactions and time.”

The configured processor subsequently queries at 306 band 306 fthe candidate as to whether an additional skill and a job title currently missing from the candidates resume dimensional values identified (FIG. 1 214) as trending for the candidate skills and/or job classifications within the Resume Metadata Repository 205 dimensional data and predicted (FIG. 1 216) as most likely matching the candidate's set of skills (and prioritized (FIG. 1 220) relative to other predicted, trending skill sets and not automatically determinable (FIG. 1 222) as accomplished by the candidate): “Have you started to work with Photoshop?” and “did your job title change to Senior Software Engineer?”.

In the example of FIG. 2A the candidate confirms in a response 308a that she has added this skill set, wherein in response the configured processor drives the chat agent to reply at 306c that the update has been responsively added to the candidate resume data dimensions (FIG. 1 226). The chat of FIG. 2A ends in further acknowledging chat messages 308b and 306d exchanged between the candidate and the configured processor (via the chat agent).

In contrast, in the example of FIG. 2B, the candidate replies in a response 308c that she has not added a suggested/predicted job title, wherein in response the configured processor drives the chat agent to acknowledge at 306g the response (and to not add the job title to the candidate resume data dimensions at FIG. 1 226). The chat of FIG. 2B includes a further query from the candidate 308d that requests determination of time in current position, wherein the configured processor (via the chat agent) determines and provides the requested information in reply 306h.

Embodiments of the present invention use machine learning processes to determine (predict, learn) a hypothetical (likely) career growth in new resume metadata values for skills, job, industry, etc., for a candidate as a function of comparing the dimensional data of resume meta representation (instantiation) of the candidate to dimensional data of other candidates stored within the Resume Metadata Repository 205, wherein the dimensional data may be only indirectly related to the identified updates, and thereby undiscoverable under conventional resume building and updating mechanisms. For example, via clustering values or recognizing other commonalities in geolocation dimensional data (for example, common geographic region, or within different geographic regions that share demographic similarities (percentages of college graduates with similar degree, or of candidates with similar job descriptions and salary ranges, etc.)) that is extracted from candidate mobile phones or governmental reporting data (tax or visa filings, etc.), embodiments may determine confidence of match of a candidate to the skills, salaries, etc. of other candidates sharing a similar dimension, wherein the shared dimensional value may bear no direct relation to the identified/predicted skill set update under conventional processes.

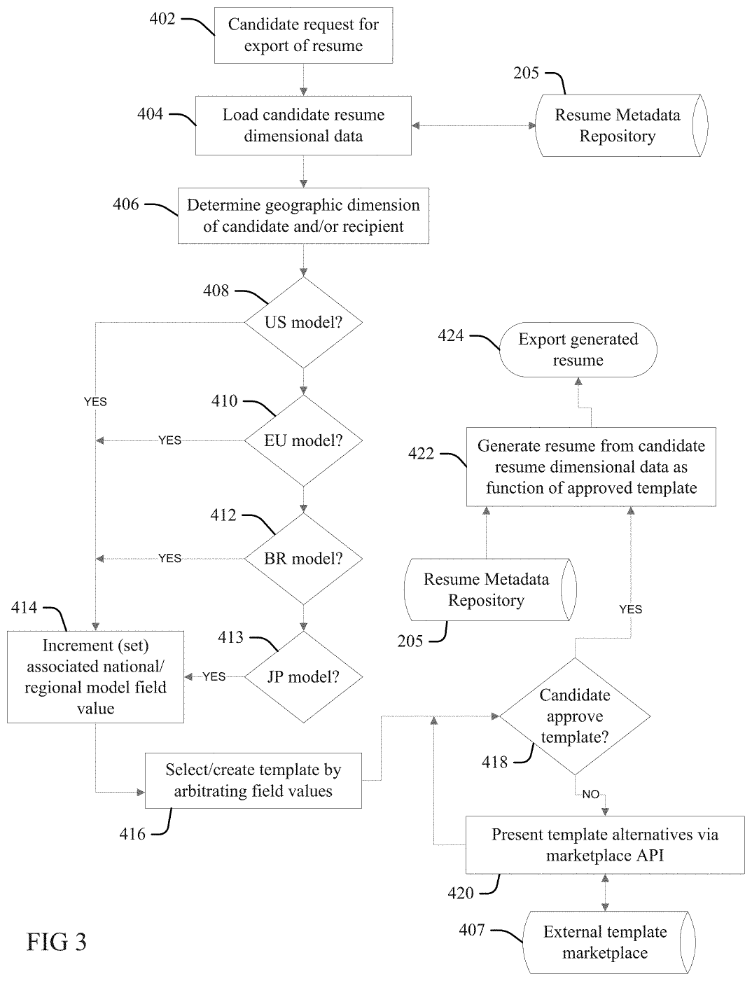

FIG. 3 illustrates a method or process embodiment of the present invention for generating a resume output from the (updated) resume metadata dimensional data for a candidate. In response to a user (candidate) request for printing, generation or other export of a resume at 402, at 404 a processor configured according to the present invention (the “configured processor”) retrieves (loads) the resume metadata dimensional data of the candidate from the Repository 205.

At 406 the configured processor determines geographic dimensional values (nation, language, dialect, etc.) of the candidate or an indicated recipient of the requested resume, and at 414 increments field values for each of a series of national or regional models for application in generating the resume.

Thus, at 414 the configured processor sets or increments national or regional template field values, as follows:

a United States (US) model field value, in response to determining at 408 that the candidate or indicated recipient (if any) of the resume is within the US, wherein the US model defines a tabular format in the American English language of one or two printed-pages maximum, with most important or relevant work experiences listed, thereby omitting less relevant experience, if necessary, in order to observe an applicable maximum page count;

a European (EU) model field value in response to determining at 410 that the candidate or indicated recipient is within the EU, wherein the EU model includes a letter format preference over other potential formats, in a preferred one of the official EU languages of a default or designated EU national location (for example, defaulting to the language of one of the candidate or recipient if the other has a non-specified EU location, or French if no national language is specified, etc.);

a Brazilian (BR) model field value in response to determining at 412 that the candidate or indicated recipient is within Brazil, wherein the Brazilian model utilizes Brazilian Portuguese language in a long form (three to four page) format as needed to include all work experience; and

a Japanese (JP) model field value in response to determining at 413 that the candidate or indicated recipient is within Japan, wherein the Japanese model includes a spreadsheet format in Japanese language characters, in preference over other potential formats.

The present examples of national/regional models considered at 408, 410, 412 and 413 are illustrative but not limiting or exhaustive, and one skilled in the art will appreciate that other national/regional models may be considered.

At 416 the configured processor selects or creates a template for use in generating a resume output as a function of arbitrating the national/regional model field values as incremented at 414. Thus, if only one regional model field value is incremented or set (for example, toggled or flagged “on” at 414 from an initialized “off” setting), then that model defines the template in that singular, preferred or default language at 416. If more than one regional model field value is incremented or set at 414, then at 416 the configured processor chooses a template that meets the requirements of each (for example, if the US and BR values are incremented, then a long-form three-plus page format is selected to meet the minimum requirements of both the US and BR model, and the resume is set for generation in both American English and Brazilian Portuguese, such as in alternating paragraphs, or in generating two separate versions), or selects a more preferred one over another (for example, if the US and EU values are set/incremented, then the US model is revised into a letter format to meet the more-preferred or base requirement of the EU model, and the language is set to American English, one of the official languages of the EU).

At 418 the configured processor presents the selected/created format to the candidate for approval. If not approved, then the configured processor opens or evokes a marketplace application programming interface (API) that presents custom templates, or template revision options (for example, different fonts, color palates, design elements, etc.) available from an external marketplace 407, which may be built or provided by external contributors. Such marketplace API's may provide additional monetization options to service providers deploying the embodiment of FIG. 3 for the benefit of the candidate (user).

Once the template designed or selected at 416, or offered via a marketplace API at 420 is approved at 418, at 422 the configured processor generates one or more resumes from the dimensional resume data of the candidate stored in the Repository 205, including as prioritized and updated at 222 and 226 in FIG. 1, as a function of the approved template(s), and exports the generated resume(s) at 424 (for example, as a paper version of a resume, or a document version using one or more digital document or object formats (PDS, DOC, XLS, etc.).

Thus, embodiments autonomously and automatically export enriched resume data updated and prioritized via machine learning processes into familiar, expected or conventional formats or styles that meet the needs or preferences of multiple recipients having different expectations and requirements as to resume format, language and cultural expectations. This is contrasted to conventional processes, which are generally limited in resume form and content generation and ability to export finished products, and fail to autonomously and dynamically update the resume data used to meet the needs and requirements of multiple different national locations as to format, languages, etc.

Thus, aspects of the present invention actively stimulate people to keep their professional resumes updated and provide solutions that store digital versions of a resume dimensional data and propose updates, via chatbot, using predictive work market trends (like new skills, job titles and knowledge fields) based on cross-user anonymized data. Aspects use multi-agent AI, an ensemble of machine learning algorithms aligned and trained to address different levels of content comprehension (text, video and audio) to enrich data with specific information about users including geolocation and accurate job skills and education and experience updates, etc., wherein the enriched data is available to serve or support other products to apply predictive machine learning algorithms for a large variety of business and data processing applications.

Conventional HR resume systems and processes are generally costly in proportion to the number of their employees, resulting in larger costs for scaling-up to meet the resume needs of increased numbers of employees. In contrast, aspects of the present invention provide advantages over conventional processes. The machine learning aspects of the embodiments described above learn associations of employee resume data that might seem disparate or otherwise unrelated to other values present within other candidate resume data that is determined to be advantageous in securing new employment, salary raises, etc., in a rapid, autonomous fashion that conventional HR resume systems would fail to recognize. By generating a multi-class output that identifiers trending demands for job classifications within dimensional data (at 214, FIG. 1), aspects may rapidly and autonomously prioritize or triage suggested or automated updates, to focus on the ones that provide the greatest likelihood of career advancement.

Moreover, the processes of predicting a closest matching set of skills for an upwardly trending job position (at 216, FIG. 1) and prioritizing missing skills for addition to resume dimension values (at 220, FIG. 1) reduce dimensional data considered in an inherent, or overt, filtering process, and embodiments thereby provide computer system data processing and other cost efficiency advantages over conventional HR resume systems and processes.

Aspects of the present invention include systems, methods and computer program products that implement the examples described above. A computer program product may include a computer-readable hardware storage device medium (or media) having computer-readable program instructions thereon for causing a processor to carry out aspects of the present invention.

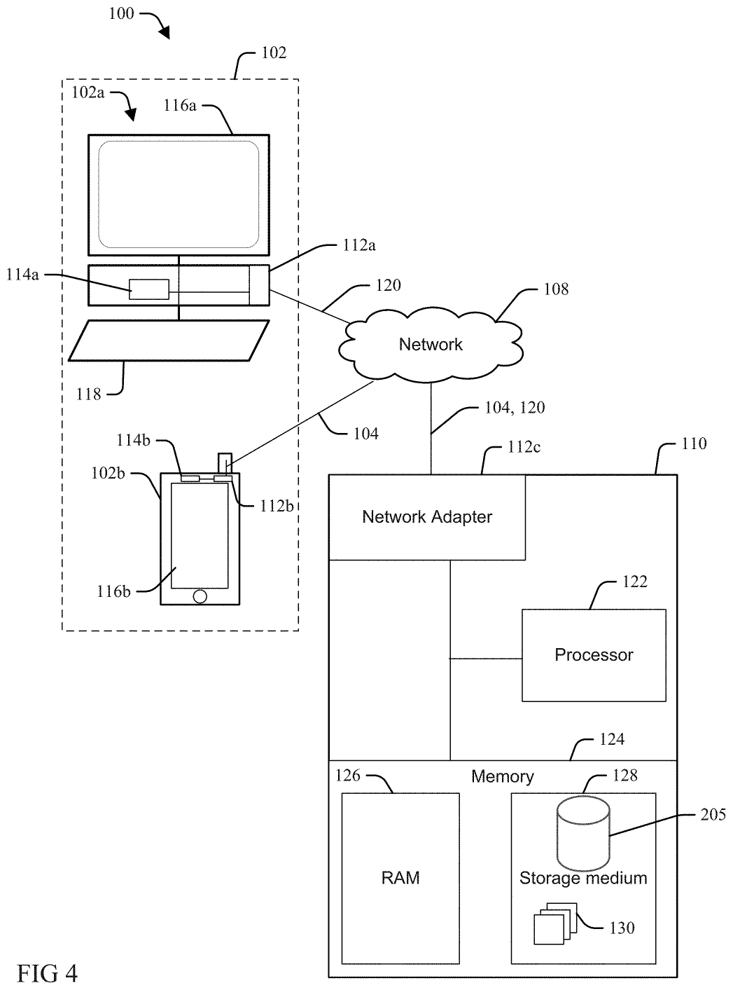

FIG. 4 is a schematic, graphic illustration of an embodiment of a system 100 for autonomous, dynamic and interactive resume generation and update based on predictive improvements determined through machine-learning and artificial intelligence processes pursuant to the process or system of FIG. 1. The system 100 includes one or more local computing devices 102, such as, for example, a desktop computer 102a, laptop computer, personal digital assistant, tablet, smartphone 102b, cellular telephone, body worn device, and the like. Lines of the schematic illustrate communication paths between the devices 102a, 102b and a computer server 110 over a network 108, and between respective components within each device. Communication paths between the local computing devices 102a and 102b and the computer server 110 over the network 108 include respective network interface devices 112a, 112b, and 112c within each device, such as a network adapter, network interface card, wireless network adapter, and the like.

In the present example, the smartphone 102b transfers (provides) candidate resume data 104 over a network 108 to a computer server 110 via their respective network interface adapters 112b and 112c , for example, including respective responses 308 to the chat bot agent of

FIGS. 2A and 2B discussed above as displayed and engaged through the graphical user interface (GUI) display 116b of the smart phone 102b .

The computer server 110 includes a processor 122 configured with instructions stored in a memory 124. The processor 122 of the computer server 110, and the processors 114a and 114b of the local computing devices 102a and 102b may include, for example, a digital processor, an electrical processor, an optical processor, a microprocessor, a single core processor, a multi-core processor, distributed processors, parallel processors, clustered processors, combinations thereof and the like. The memory 124 includes a computer readable memory 126 and a computer readable storage medium 128.

The computer server 110, in response to receiving the candidate response data 104, updates the resume dimension data stored in the Repository 205 with missing skills predicted as matching (appropriate) for upwardly trending job positions (at 216, FIG. 1) and prioritized for addition to resume dimension values (at 220, FIG. 1) as described above with respect to FIG. 1.

The computer server 110 further exports generated resume data 120 (at 424, FIG. 3) over the network 108 to the local computing device 102a via their respective network interface adapters 112c and 112a . The local computing devices 102 includes one or more input devices 118 (such as a keyboard, mouse, microphone, touch screen, etc.), and respective processors 114a and 114b which drive respective display devices 116a and 116b, to generate and display a presentation of at least a portion of the exported, generated resume data 120.

The computer readable storage medium 128 can be a tangible device that retains and stores instructions for use by an instruction execution device, such as the processor 122. The computer readable storage medium 128 may be, for example, but is not limited to, an electronic storage device, a magnetic storage device, an optical storage device, an electromagnetic storage device, a semiconductor storage device, or any suitable combination of the foregoing. A computer readable storage medium 128, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

In contrast to conventional HR resume generation and updating (maintenance), embodiments of the present invention provide advantages by more timely updating resume information, thereby reducing inaccuracies; periodically query people to update the information, preventing harm through neglect; protect from mistaken impression that such prompted updating is driven by unhappiness with a current position or active efforts to leave a current employer; reduce risk of loss from forgetting to add important skills or achievements; ensure that dynamic information changes do not result in data deficiencies via a failure to regularly review and revise information to meet new requirements as they arise, including those of different national or cultural jurisdictions; eliminate lengthy and tedious efforts on the part of the candidate to create and maintain an updated resume across a variety of different required document, object or other data structures and formats, tools, portals and social media platforms; prevent bad impressions conveyed by outdated or poor resume data; prevent problems in accurate and timely translating to different languages and expected data formats (via automated modality and template selection) as required for different organizations, departments or foreign jurisdictions; and update job titles to correspond to similar usage within positions encompassing the same job or job duties within other organizations and jurisdictions, increasing value in enabling better assessment of the suitability of a candidate for a relevant position.

Embodiments learn and provide insights with regard to beneficial and desired skills, in view of market trends. By making the act of updating resume data a more frequent and regular occurrence relative to conventional systems and processes (via the refresh period mechanisms), embodiments encourage candidates to make a regular habit of updating their resume, and directly and indirectly increase user's (candidate's) awareness about their own career status and progression, which may increase user confidence and resolve and thereby generate positive impacts within and outside of the work environment.

Computer readable program instructions described herein can be transmitted to respective computing/processing devices from the computer readable storage medium 128 or to an external computer or external storage device via the network 108. The network 108 can include private networks, public networks, wired networks, wireless networks, data networks, cellular networks, local area networks, wide area networks, the Internet, and combinations thereof. The network interface device 112 in each device receives computer readable program instructions from the network 108 and forwards the computer readable program instructions for storage in the computer readable storage medium 128 within the respective computing/processing device.

Computer readable program instructions for carrying out operations of the present invention may include assembler instructions, instruction-set-architecture (ISA) instructions, machine instructions, machine dependent instructions, microcode, firmware instructions, state-setting data, configuration data for integrated circuitry, compiled or interpreted instructions, source code or object code written in any combination of one or more programming languages or programming environments, such as Java®, Javascript®, (JAVA and JAVESCRIPT are trademark of Oracle America, Inc., in the United States or other countries), C, C#, C++, Python, Cython, F#, PHP, HTML, Ruby, and the like.

The computer readable program instructions may execute entirely on the computer server 110, partly on the computer server 110, as a stand-alone software package, partly on the computer server 110 and partly on the local computing device 102 or entirely on the local computing device 102. For example, the local computing device 102 can include a web browser that executes HTML instructions transmitted from the computer server 110, and the computer server executes Java® instructions that construct the HTML instructions. In another example, the local computing device 102 includes a smartphone application, which includes computer readable program instructions to perform the processes described above.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general-purpose computer, special purpose computer, or other programmable data processing apparatus to produce a machine (“a configured processor”), such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the blocks may occur out of the order noted in the Figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

The memory 124 can include a variety of computer system readable media. Such media may be any available media that is accessible by computer server 110, and the media includes volatile media, non-volatile media, removable, non-removable media, and combinations thereof. Examples of the volatile media can include random access memory (RAM) and/or cache memory. Examples of non-volatile memory include magnetic disk storage, optical storage, solid state storage, and the like. As will be further depicted and described below, the memory 124 can include at least one program product having a set (e.g., at least one) of program modules 130 that are configured to carry out the functions of embodiments of the invention.

The computer system 100 is operational with numerous other computing system environments or configurations. Examples of well-known computing systems, environments, and/or configurations that may be suitable for use with computer system 100 include, but are not limited to, personal computer systems, server computer systems, thin clients, thick clients, hand-held or laptop devices, multiprocessor systems, microprocessor-based systems, set top boxes, programmable consumer electronics, network PCs, minicomputer systems, mainframe computer systems, and distributed cloud computing environments that include any of the above systems or devices, and the like.

In one aspect, a service provider may perform process steps of the invention on a subscription, advertising, and/or fee basis. That is, a service provider could offer to integrate computer-readable program code into the computer system 100 to enable the computer system 100 to perform the processes of FIGS. 1 through 3 discussed above. The service provider can create, maintain, and support, etc., a computer infrastructure, such as components of the computer system 100, to perform the process steps of the invention for one or more customers. In return, the service provider can receive payment from the customer(s) under a subscription and/or fee agreement and/or the service provider can receive payment from the sale of advertising content to one or more third parties. Services may include one or more of: (1) installing program code on a computing device, such as the computer device 110, from a tangible computer-readable medium device 128; (2) adding one or more computing devices to the computer infrastructure 100; and (3) incorporating and/or modifying one or more existing systems 110 of the computer infrastructure 100 to enable the computer infrastructure 100 to perform process steps of the invention.

The terminology used herein is for describing particular aspects only and is not intended to be limiting of the invention. As used herein, the singular forms “a”, “an” and “the” are intended to include the plural forms as well, unless the context clearly indicates otherwise. It will be further understood that the terms “include” and “including” when used in this specification, specify the presence of stated features, integers, steps, operations, elements, and/or components, but do not preclude the presence or addition of one or more other features, integers, steps, operations, elements, components, and/or groups thereof. Certain examples and elements described in the present specification, including in the claims and as illustrated in the figures, may be distinguished or otherwise identified from others by unique adjectives (e.g. a “first” element distinguished from another “second” or “third” of a plurality of elements, a “primary” distinguished from a “secondary” one or “another” item, etc.) Such identifying adjectives are generally used to reduce confusion or uncertainty and are not to be construed to limit the claims to any specific illustrated element or embodiment, or to imply any precedence, ordering or ranking of any claim elements, limitations or process steps.

The descriptions of the various embodiments of the present invention have been presented for purposes of illustration but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

What is claimed is:

1 A computer-implemented method, comprising:
mapping values of resume data for a first candidate to a resume metadata representation of the first candidate comprising a plurality of data dimensions that are stored within a metadata repository, wherein the metadata repository comprises resume metadata representation data dimensions for each of a plurality of candidates inclusive of the first candidate;
learning via a machine learning process different trending demand values for each of a plurality of job classifications within the dimensional data as a function of employment data;
identifying via the machine learning process, as a function of the learned trending demand values and of values of the first candidate data dimensions, a skill of an upwardly trending job position that is missing from the first candidate data dimensions and is most likely to match a current skill set of the first candidate;
adding the identified skill of the upwardly trending job position to the first candidate data dimensions; and
generating a resume for the first candidate as a function of the first candidate data dimensions to include the added skill.

2. The method of claim 1, further comprising:
acquiring resume data from the first candidate comprising current and historic employment, job skills and education information;
extracting additional resume data for the first candidate from the sources identified as relevant to the first candidate or to the acquired resume data; and
generating confirmed resume data values via disambiguation of the extracted and acquired data; and
wherein the mapping the values of resume data for the first candidate to the resume metadata representation of the first candidate comprises mapping the generating confirmed resume data values.

3. The method of claim 2, wherein the extracted additional resume data is selected from the group consisting of:
changes that are extracted from postings linked to the candidate within a social media service that are selected from the group consisting of marital status, domicile, residence, nationality, visa status, job title, education information and employer information;
text content data that is extracted from a newsfeed, a governmental record, a credit report agency record or an insurance company record;
climate data for residence, work and travel locations of the candidate;
news events extracted from a new media source comprising an employment-related new announcement; and
operating system and current and historic geolocation data extracted from a mobile device of the candidate.

4. The method of claim 3, wherein the identifying the skill of the upwardly trending job position that is missing from the first candidate data dimensions and is most likely to match the current skill set of the first candidate is a function of clustering dimensional values mapped from the extracted additional resume data.

5. The method of claim 1, wherein the adding the identified skill of the upwardly trending job position to the first candidate data dimensions comprises:
querying the first candidate via a chat bot agent to determine whether the first candidate has achieved said skill; and
adding the skill in response to an affirmative reply from the first candidate.

6. The method of claim 1, wherein the generating the resume for the first candidate comprises:
determining a geographic location of a recipient of the resume;
selecting a national model that is associated to the geographic location of the recipient that specifies a preferred resume format and a preferred language of a nation of the geographic location; and
exporting the generated resume in the preferred resume format and the preferred language of the nation of the geographic location.

7. The method of claim 6, wherein the preferred resume format is selected from the group consisting of a maximum page length, a minimum page length, a text content formatting style, a spreadsheet format, and an amount of work experience history of the candidate.

8. The method of claim 1, further comprising:
integrating computer-readable program code into a computer system comprising the processor, a computer readable memory in circuit communication with the processor, and a computer readable storage medium in circuit communication with the processor; and
wherein the processor executes program code instructions stored on the computer-readable storage medium via the computer readable memory and thereby performs the mapping the values of the resume data, the learning the different trending demand values, the identifying the skill of the upwardly trending job position missing from the first candidate data dimensions, the adding the identified skill to the first candidate data dimensions, and the generating the resume.

9. The method of claim 8, wherein the computer-readable program code is provided as a service in a cloud environment.

10. A system, comprising:
a processor;
a computer readable memory in circuit communication with the processor; and
a computer readable storage medium in circuit communication with the processor; and
wherein the processor executes program instructions stored on the computer-readable storage medium via the computer readable memory and thereby:
maps values of resume data for a first candidate to a resume metadata representation of the first candidate comprising a plurality of data dimensions that are stored within a metadata repository, wherein the metadata repository comprises resume metadata representation data dimensions for each of a plurality of candidates inclusive of the first candidate;
learns, via a machine learning process different trending demand values for each of a plurality of job classifications within the dimensional data as a function of employment data;
identifies via the machine learning process, as a function of the learned trending demand values and of values of the first candidate data dimensions, a skill of an upwardly trending job position that is missing from the first candidate data dimensions and is most likely to match a current skill set of the first candidate;
adds the identified skill of the upwardly trending job position to the first candidate data dimensions; and
generates a resume for the first candidate as a function of the first candidate data dimensions to include the added skill.

11. The system of claim 10, wherein the processor executes the program instructions stored on the computer-readable storage medium via the computer readable memory and thereby:
acquires resume data from the first candidate comprising current and historic employment, job skills and education information;
extracts additional resume data for the first candidate from the sources identified as relevant to the first candidate or to the acquired resume data;
generates confirmed resume data values via disambiguation of the extracted and acquired data; and
maps the values of resume data for the first candidate to the resume metadata representation of the first candidate by mapping the generating confirmed resume data values.

12. The system of claim 11, wherein the extracted additional resume data is selected from the group consisting of:
changes that are extracted from postings linked to the candidate within a social media service that are selected from the group consisting of marital status, domicile, residence, nationality, visa status, job title, education information and employer information;
text content data that is extracted from a newsfeeds, a governmental record, a credit report agency record or an insurance company record;
climate data for residence, work and travel locations of the candidate;
news events extracted from a new media source comprising an employment-related new announcement; and
operating system and current and historic geolocation data extracted from a mobile device of the candidate.

13. The system of claim 12, wherein the processor executes the program instructions stored on the computer-readable storage medium via the computer readable memory and thereby:
identifies the skill of the upwardly trending job position that is missing from the first candidate data dimensions and is most likely to match the current skill set of the first candidate as a function of clustering dimensional values mapped from the extracted additional resume data.

14. The system of claim 10, wherein the processor executes the program instructions stored on the computer-readable storage medium via the computer readable memory and thereby adds the identified skill of the upwardly trending job position to the first candidate data dimensions by:
querying the first candidate via a chat bot agent to determine whether the first candidate has achieved said skill; and
adding the skill in response to an affirmative reply from the first candidate.

15. The system of claim 10, wherein the processor executes the program instructions stored on the computer-readable storage medium via the computer readable memory and thereby generates the resume for the first candidate by:
determining a geographic location of a recipient of the resume;
selecting a national model that is associated to the geographic location of the recipient that specifies a preferred resume format and a preferred language of a nation of the geographic location; and
exporting the generated resume in the preferred resume format and the preferred language of the nation of the geographic location; and
wherein the preferred resume format is selected from the group consisting of a maximum page length, a minimum page length, a text content formatting style, a spreadsheet format, and an amount of work experience history of the candidate.

16. A computer program product, comprising:
a computer readable storage medium having computer readable program code embodied therewith, wherein the computer readable storage medium is not a transitory signal per se, the computer readable program code comprising instructions for execution by a processor that cause the processor to:
map values of resume data for a first candidate to a resume metadata representation of the first candidate comprising a plurality of data dimensions that are stored within a metadata repository, wherein the metadata repository comprises resume metadata representation data dimensions for each of a plurality of candidates inclusive of the first candidate;
learn via a machine learning process different trending demand values for each of a plurality of job classifications within the dimensional data as a function of employment data;
identify via the machine learning process, as a function of the learned trending demand values and of values of the first candidate data dimensions, a skill of an upwardly trending job position that is missing from the first candidate data dimensions and is most likely to match a current skill set of the first candidate;
add the identified skill of the upwardly trending job position to the first candidate data dimensions; and
generate a resume for the first candidate as a function of the first candidate data dimensions to include the added skill.

17. The computer program product of claim 16, wherein the computer readable program code instructions for execution by the processor further cause the processor to:
acquire resume data from the first candidate comprising current and historic employment, job skills and education information;
extract additional resume data for the first candidate from the sources identified as relevant to the first candidate or to the acquired resume data;
generate confirmed resume data values via disambiguation of the extracted and acquired data; and
map the values of resume data for the first candidate to the resume metadata representation of the first candidate by mapping the generating confirmed resume data values.

18. The computer program product of claim 17, wherein the extracted additional resume data is selected from the group consisting of:
changes that are extracted from postings linked to the candidate within a social media service that are selected from the group consisting of marital status, domicile, residence, nationality, visa status, job title, education information and employer information;
text content data that is extracted from a newsfeeds, a governmental record, a credit report agency record or an insurance company record;
climate data for residence, work and travel locations of the candidate;
news events extracted from a new media source comprising an employment-related new announcement; and
operating system and current and historic geolocation data extracted from a mobile device of the candidate.

19. The computer program product of claim 18, wherein the computer readable program code instructions for execution by the processor further cause the processor to:
identify the skill of the upwardly trending job position that is missing from the first candidate data dimensions and is most likely to match the current skill set of the first candidate as a function of clustering dimensional values mapped from the extracted additional resume data.

20. The computer program product of claim 16, wherein the computer readable program code instructions for execution by the processor further cause the processor to generate the resume for the first candidate by:
determining a geographic location of a recipient of the resume;
selecting a national model that is associated to the geographic location of the recipient that specifies a preferred resume format and a preferred language of a nation of the geographic location; and
exporting the generated resume in the preferred resume format and the preferred language of the nation of the geographic location; and
wherein the preferred resume format is selected from the group consisting of a maximum page length, a minimum page length, a text content formatting style, a spreadsheet format, and an amount of work experience history of the candidate.
